(19) United States
(12) Patent Application Publication
(10) Pub. No.: US 2019/0275664 A1
(43) Pub. Date: Sep. 12, 2019

(54) MAGNETIC TOOL ORGANIZER

(71) Applicant: Michael Pingitore, Nashville, TN (US)

(72) Inventor: Michael Pingitore, Nashville, TN (US)

(21) Appl. No.: 16/289,160

(22) Filed: Feb. 28, 2019

Related U.S. Application Data
(60) Provisional application No. 62/640,213, filed on Mar. 8, 2018.

(51) Int. Cl. B25H 3/00; B25H 3/04

(52) U.S. Cl. CPC B25H 3/003; B25H 3/04

(57) ABSTRACT

A magnetic tool organizing system for storing large tools and garden tools in the garage. The system includes a metal sheet mounted to a wall and adjustable magnetic tool strap unit that attaches to the metal sheet for holding tools. The tool strap unit includes a magnet attached to a backing sheet with a strap for securing tools. The tool strap unit is magnetically attached to the metal sheet on wall in any position desired by the user, thereby creating a maximally efficient use of wall space for storage of tools. Bin and hook units magnetically attached to the metal sheet may also be used. The metal sheet increases space for tool storage, and provides a blank canvas for tool storage locations and orientations. Adjustable tool strap units can be secured to a variety of tools and garage items to be attached and stored on the walls.

### FIELD

The present disclosure relates to a wall storage system for large tools and garden tools in a garage or work area.

### RELATED ART

Within a basement or a garage, whether attached or detached, space limitations and organization can create problems for tool storage. With limited amounts of space for storing tools, a homeowner benefits from maximizing the area in which tools can be stored. Everything from an adjustable wrench to a step stool requires efficient use of space in a storage area of a home. To solve the problem of tool storage in a home, wall storage systems have been developed. Such systems allow for the hanging of tools such as rakes, brooms, ladders and the like.

The typical garage wall storage solution utilizes a track or rail system for organization. These systems often require planning to ensure the proper location and height of the track to be useful now, in the future, and when acquiring new tools. For example, U.S. Pat. No. 7,900,781 discloses a storage system that requires a track to be mounted to the wall for storage. A second form of storage has a wall board of larger size with slots, holes, or pins that can be utilized for the connection of an assortment of specialized hooks. These systems offer more freedom in the layout of storage, but still require planning when layout changes are needed. For example, U.S. Pat. No. 7,775,492 discloses a wall panel with holes for specialized hook mounting. Therefore, these systems require excessive planning of component layout and further planning when alterations are needed.

Existing wall storage systems require the purchase of an assortment of hooks, arms, and devices in order to organize, store, and clear floor space. Existing storage systems often rely on tracks or boards mounted on the walls as the basis of the system. These mounting surfaces quickly limit the functionality of the storage solution as they limit the functional space. If the user has a tool that is too tall for the installed hook or location of the track, the system loses all functionality. Referring again to U.S. Pat. No. 7,775,492, several different styles of hooks are shown and are required based on the tool being stored. In turn, this type of system requires significant pre-planning and various purchases for all the items needing storage such that the proper hook is available when needed. Additionally, in existing systems, tools must be spaced out properly before storage in order for proper fit and orientation of items. Such systems are not designed for tools of odd shapes, handle sizes, or lengths of handle. In these systems, properly planning the location of hooks may provide a temporary desired result, however, if an additional tool is added later, the whole system may need to be reorganized in order to accommodate a new tool.

Thus, existing technology relating to wall tool storage has demonstrated limitations. Therefore, a need exists to provide an easy to utilize system that can accommodate tools of various sizes, shapes and lengths. In addition, a system that offers minimum planning, quick setup, and fast alterations when and where required is needed.

### SUMMARY

The present disclosure avoids the drawbacks of known wall storage systems for tools by providing a system which offers the ability to quickly install a working system while also allowing for changes when new tools are added to the system, thereby creating an enhanced and transformative garage and basement storage system.

The tool storage system disclosed herein includes a metal sheet mounted to a wall and adjustable magnetic tool strap unit that attaches to the metal sheet. The tool strap unit includes a magnet attached to a backing s that includes a strap for securing tools. The tool strap unit is magnetically attached to the metal sheet on wall in any position desired by the user, thereby creating a maximally efficient use of wall space for storage of tools. Bins and hook units magnetically attached to the metal sheet are also contemplated within the present disclosure. The metal sheet allows a larger space for tool storage, as well as a blank canvas for tool storage locations and orientations. There is no preset hook or peg location for a tool, and every area on the metal sheet can be utilized. The adjustable tool strap units can be secured to a variety of tools and garage items to be attached and neatly stored on the walls. One embodiment may incorporate a hinge on the tool strap unit in order to accommodate a wide variety of tools. In addition, a hook and tool bin unit may allow further optimization of the system. The orientation of the tool strap units on a particular tool does not affect the function of the system, thereby allowing for a secure fit to the metal sheet in any direction.

The preceding is a general summary of embodiments of the disclosure intended to provide an understanding of certain aspects of the disclosure. It is intended to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

FIG. 1 illustrates a perspective view of the system in use, in accordance with an embodiment of the present disclosure;

FIG. 2 illustrates a front perspective view of the tool strap unit, in accordance with an embodiment of the present disclosure;

FIG. 3 illustrates a rear perspective view of the tool strap unit, in accordance with an embodiment of the present disclosure;

FIG's. 4A, 4B and 4C illustrate a rear perspective view of the tool strap unit partially rotated, fully rotated at a 90-degree angle along the pivot hinge, and fully rotated at a 90-degree angle along the hinge with a tool attached, respectively, in accordance with an embodiment of the present disclosure;

FIG. 5, illustrates a front perspective view of the tool strap unit partially rotated along the hinge, in accordance with an embodiment of the present disclosure;

FIG. 6 illustrates a rear perspective view of a tool hook unit, in accordance with an embodiment of the present disclosure;

FIG. 7 illustrates a rear perspective view of a tool bin unit, in accordance with an embodiment of the present disclosure;

FIG's. 8A, 8B and 8C illustrate a front perspective view, a rear perspective view, and a cross sectional view, respectively, in accordance with an embodiment of the present disclosure;

FIG's. 9A, 9B and 9C illustrate a rear perspective view, a cross sectional side view, and a front perspective view of the tool strap unit in accordance with an embodiment of the present disclosure;

FIG. 10 illustrates a rear perspective view of the tool strap unit with recessed magnets, in accordance with an embodiment of the present disclosure;

FIG. 11 illustrates a rear perspective view of the tool strap unit with an outer non-slip coating, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

In the following detailed description, numerous specific details are set forth in order to provide a thorough understanding of embodiments or other examples described herein. In some instances, well-known methods, procedures, and components have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

The disclosure will be illustrated below in conjunction with a magnetic tool organization system.

The exemplary systems and methods of this disclosure will also be described. However, to avoid unnecessarily obscuring the present disclosure, the following descriptions omit well-known structures, components and devices that may be shown in diagram and drawing form, are well known, or are otherwise summarized.

As used herein, the term “magnet” refers generally to a piece of iron that has its component atoms so ordered that the material exhibits properties of magnetism, such as attracting other iron-containing objects or aligning itself in an external magnetic field. For example, a magnet be made of iron or an ore, alloy, or other material that may also exhibit properties of magnetism.

As used herein, the term “tool” refers generally to a device, utilized to carry out a particular function. For example, a tool may be a rake, shovel, electric drill, ladder, screws and bits, and the like.

Embodiments in accordance with the present disclosure provide a system for garage organization that offers limitless utilization and alteration of storage space.

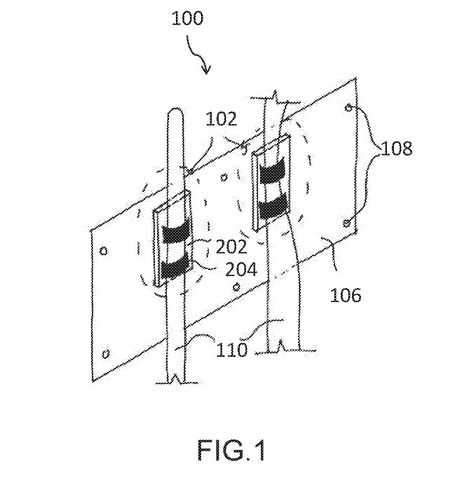

FIG. 1 illustrates a perspective view of the system 100 in use, in accordance with an embodiment of the present disclosure. The magnetic garage organizer may be referred to herein as system 100. System 100 may include a plurality of tool strap units, as shown in a general arrangement on a metal sheet 106, which can be of a multitude of shapes (e.g., rectangular, square, organic, etc.), sizes, and thicknesses. The tool strap units 102, hold various tools, as shown, while here the tool 110 is shown as the handle of a broom and an axe. The tool 110 is shown in a vertical orientation, however the tool 110, which may be of a multitude of shapes and sizes, can be oriented in any direction for use with tool strap unit 102. Metal sheet 106 also allows system 100 to be modular by allowing a user to add metal sheet 106 to an existing system 100 or as a remote mounting location. Tool 110 with tool strap unit 102 can be mounted at any metal sheet 106 in any location, as needed.

In addition, system 100 may include mounting holes 108 which can be of various sizes, quantities, and at various locations on metal sheet 106. The arrangement and quantity may differ based on the size, shape, and loading limitations determined for metal sheet 106. Mounting holes 108 may be oriented at standard building stud spacing, thereby simplifying user installation.

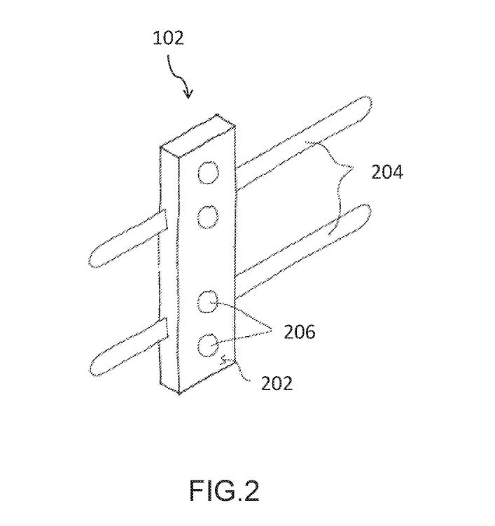

FIG. 2 illustrates a front view of the tool strap unit 102, in accordance with an embodiment of the present disclosure. Backing plate 202, as shown, links all of the components of tool strap unit 102. Backing plate 202 may be comprised of a variety of materials (e.g., plastic, silicone, carbon fiber, etc.) which may be selected and designed for strength, durability, and manufacturing ease. FIG.2 show backing plate 202 as a connection point for strap 204. In a first embodiment, backing plate 202 may have a height 4.5″; a width of 0.75″ a depth of ⅛″ and a weight of approximately 0.08 oz. In a first embodiment, backing plate 202 may be comprised of wood.

Strap 204 functions to fasten the tool strap unit 102 to any tool 110 and may be comprised of a variety of materials. Strap 204 encompasses various sizes, shapes and lengths of handles to be fastened with the same ease. Attachment portions of strap 204, which are located at a first and second end of strap 204 may be comprised of a hook and loop fastener, such as VELCRO™ or a button snap, or other means of attachment that would be known to one of ordinary skill in the art. In addition, straps 204 allow for the removal, rearrangement, or replacement of tool strap unit 102 whenever required or desired. With regard to FIG.2, two straps 204 are shown, however tool strap unit 102 may, in some embodiments, include one strap or a multitude of straps 204 with no variation on the design intent or functionality. In a first embodiment, strap 204 may have a length of 8″, a width of ½″, and a depth of 1/32″. Strap 204 may have a first end and a second end comprised of a hook and loop fastener such as VELCRO™. Strap 204 may, in one embodiment, be comprised of nylon and polyester.

Strap 204 may be attached to backing plate 202 in a variety of ways. Strap 204 may be molded into backing plate 202 material when formed or bonded to backing plate 202 after formation. In addition, backing plate 202 may have an opening or horizontal passage (e.g. slots, sleeve, hooks) allowing the insertion, alteration, or removal of strap 204 by the user. A variety of means for attaching tool strap 204 to backing plate 202 are contemplated within the present disclosure, as would be known to one of ordinary skill in the art.

Referring to FIG. 2, grippers 206 are depicted connected to backing plate 202. The connection method may be of a variety of styles (e.g., molded, glued, etc.) to enhance the functionality and manufacturing ease of the system. Grippers 206 may be comprised of various materials (e.g., rubber, silicon, composite) in order to increase grip of backing plate 202 on a tool handle, thereby minimizing the risk of tool 110 slipping. In this depiction, four round grippers 206 are shown, however one skilled in the art will appreciate the feasibility that the shape of gripper 206 (e.g., round, square, etc.) may vary with regard to optimization of system 100 without changing the design intent of the present disclosure. Furthermore, one skilled in the art will appreciate the feasibility that grippers 206 may be in a pattern formed into the molding of backing plate 202 in order to offer a textured surface for gripping.

Lastly, backing plate 202 may include a hinge 208 as shown in FIG's 4A, 4B, 4C and 5. Hinge 208 may allow flexibility in the type of tool 110 that can be secured with the system 100. Whether the tool 110 has a straight handle, 90-degree handle, or any angle in between, tool strap unit 102 can be properly secured when hinge 208 is utilized. With a design that includes grippers 206, tool strap unit 102, and hinge 208, any combination of tool style may be accommodated.

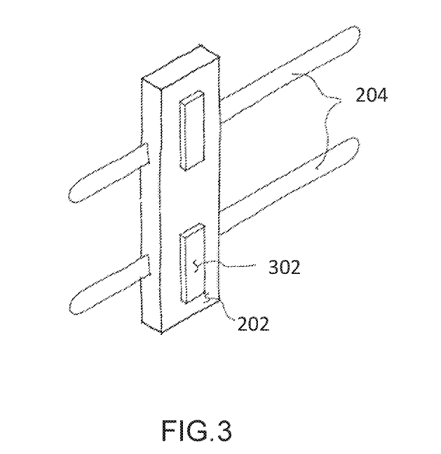

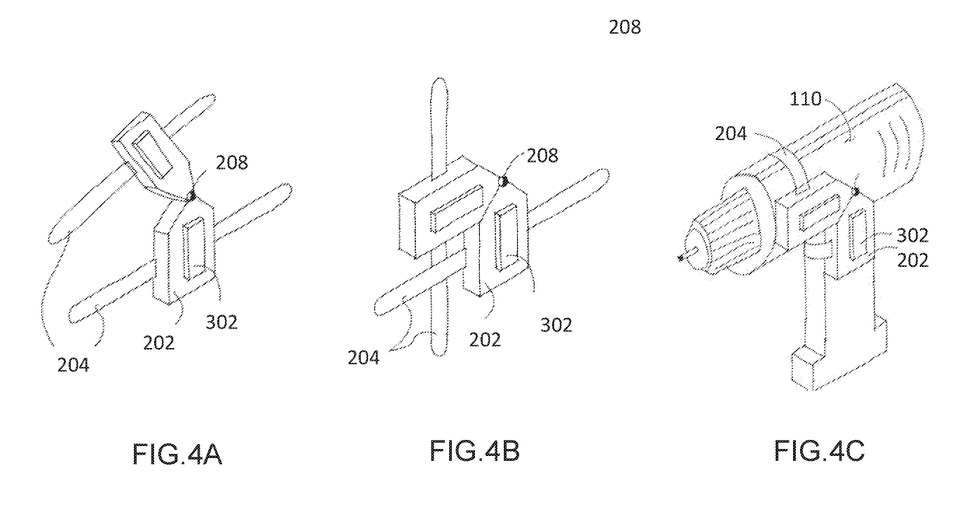

FIG. 3 illustrates a rear view of the tool strap unit 102, in accordance with an embodiment of the present disclosure. Here, magnet 302 is clearly seen on backing plate 202. Magnet 302 may be of various sizes and shapes, and designed to handle a certain capacity of weight, without changing the design intent in the present disclosure. Strength and size of magnet 302 is adapted and optimized to allow for magnet 302 to attach common household tools 110 such as a rake, a shovel and a drill to a wall, but magnet 302 may not be so strong as to prevent removal of a tool, rake or shovel stored above the height of a user. For example, a tool 110 stored above a user, according to the present disclosure, may be pried or pulled away from a wall using leverage, while the magnet 302 would be strong enough to hold the tool 110 in place on the wall. In a first embodiment, with regard to dimensions, magnet 302 has a height 1.5″ stacked in the vertical direction for a total of 3″; a width of ½″ and a depth of ¼″. In one embodiment, magnet 302 may be comprised of Neodymium (Nickel-Copper-Nickel coating to protect from rust).

In addition, the quantity of magnets 302 included on backing plate 202 may be designed for loading without altering the design intent. Magnet 302 may be attached to backing plate 202 in a variety of ways, including but not limited to glue, molding techniques, clasps, etc. The design of the mounting system for magnet 302 may be engineered to handle the load requirements of the system 100. In addition, magnet 302 may not be fully visible to the user. Magnet 302 may be formed into and covered by backing plate 202 material (e.g. molded into, coated over, etc.) as to offer a non-slip surface between magnet 302 and metal sheet 106. The non-slip material may include rubber, silicon, composite, foam, vinyl, cloth and other flexible materials having a shore hardness lower than that of metal, wherein low shore hardness is herein defined as a shore hardness below 50 as measured on a shore durometer. The non-slip surface may also be an add on feature, during production, and not a part of the initial mold or coating. Non-slip surface may increase the holding power of the magnet 302.

Referring now to FIG's 4A, 4B and 4C, hinge 208 may pivot two sections, or halves, of backing plate 202 freely. This will allow a user to attach one section of backing plate 202 using tool strap unit 102 to tool 110 handle, then pivot the other section of backing plate 202 such that it is parallel with the tool 110 handle in the secondary direction. In most cases, tool strap unit 102 may be left in place during tool 110 operation allowing easy retrieval and fast storage of tool 110. In a hinged embodiment of the present disclosure, a first backing plate section and a second backing plate section may be of an identical shape, each having a triangular portion and a rectangular portion, wherein a vertex of the triangular portion of the first backing plate section is linked by hinge 208 to a vertex of the triangular portion of the second backing plate section, such that the first backing plate section and the second backing plate section rotate latitudinally to form a 90 degree angle between the longitudinal axis of the first backing plate and the longitudinal axis of the second backing plate section.

Referring to FIG. 4C, an example of tool 110, here shown as a drill, shows hinge 208 allows the strap to attach easily. If the handle of tool 110 did not form a 90-degree angle, tool strap unit 102 could still flex to the desired degree for attachment. Other examples of tool 110 that may use system 100 include an ax, with a wide and tapering handle, a rake, with a large diameter round handle, and a screw gun with a 90 degree turn in the handle. Strap unit 102 allows variation in tool 110 with the design components discussed herein.

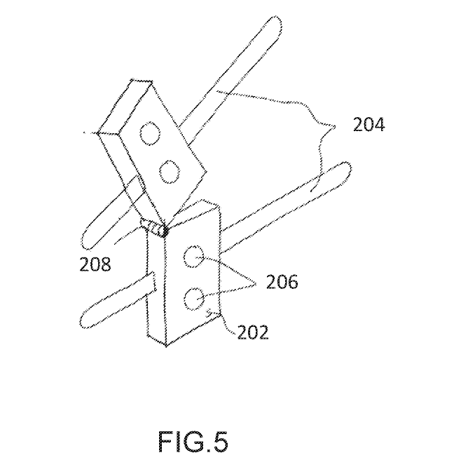

With regard to FIG.5, in one embodiment, the first backing plate section and the second backing plate section are rectangular, wherein the first backing plate section is linked by a hinge 208 to the second backing plate section; wherein hinge 208 is positioned along the divide between a first vertical side of the first backing plate section and a first vertical side of the second backing plate section. Here, the backing plate sections may rotate 180 degrees in one direction. Alternatively, hinge 208 may stop rotating at 90 degrees.

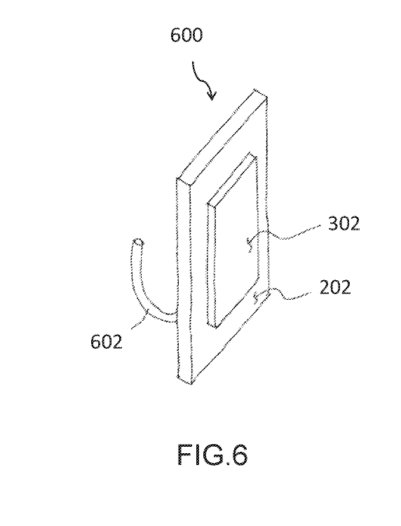

FIG. 6 illustrates a perspective view of a tool hook unit 600, in accordance with an embodiment of the present disclosure. The tool hook unit 600 has a hook 602 that may be mounted to the backing plate 202 which incorporates the magnet 302. The tool hook unit allows an alternative mounting solution for a variety of tools with the same benefits as the tool strap unit 102. The tool hook unit 600 can be mounted at infinite locations on the metal sheet 106 offering flexibility to system 100.

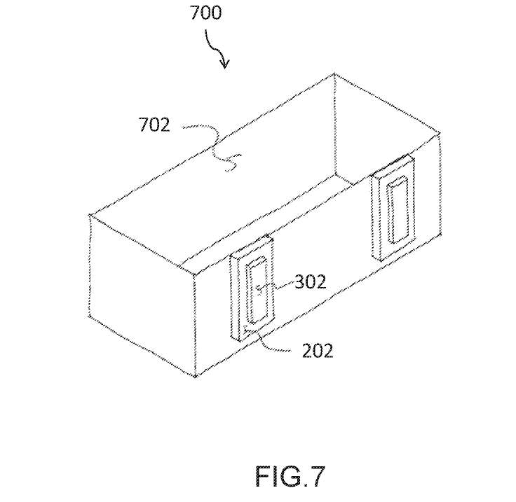

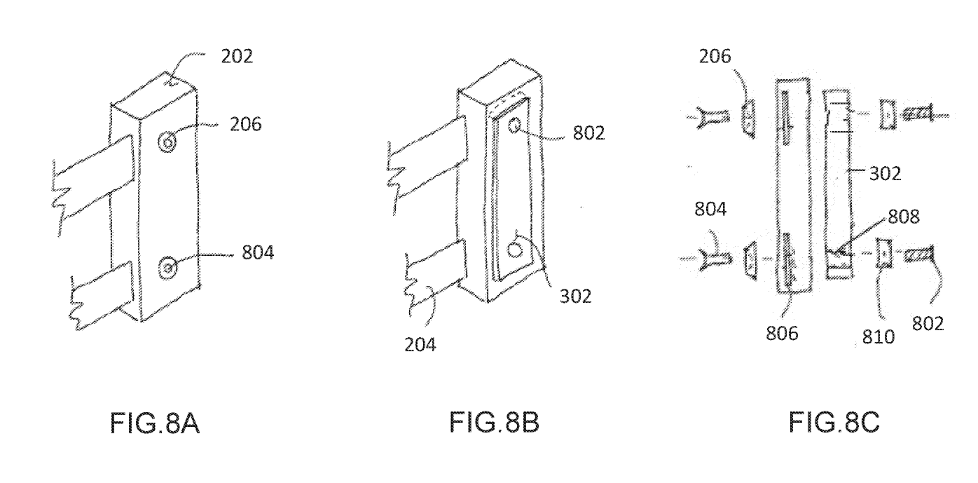

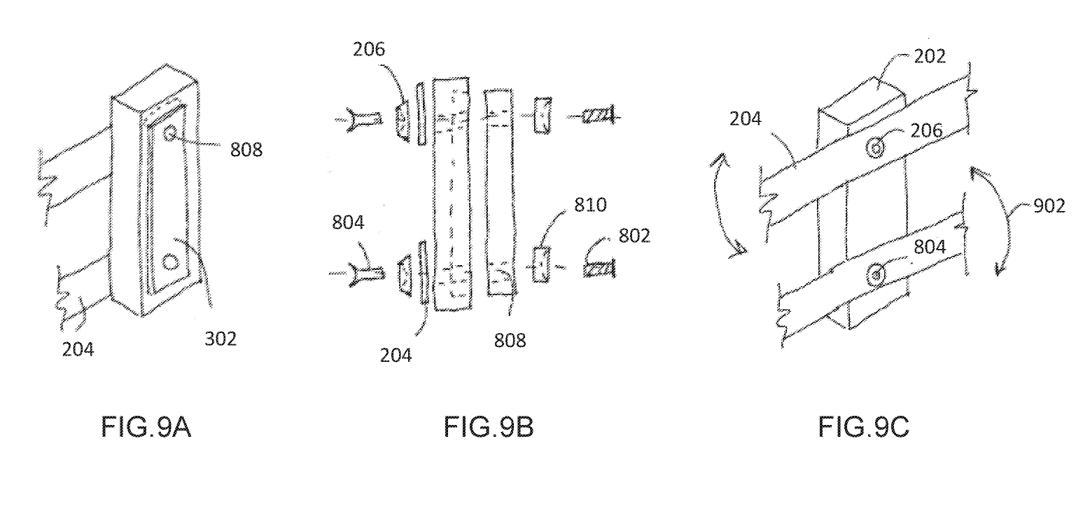

FIG. 7 illustrates a perspective view a tool bin unit, in accordance with an embodiment of the present disclosure. Tool bin unit 700 is comprised of a bin 702 along with mounted backing plates 202 incorporating magnets 302. FIG. 7. depicts two backing plates 202 and two magnets 302. However, the design and size of bin 702 may be engineered for particular holding capabilities and strength which may require a variety in shape and quantity of backing plates 202 and magnets 302. In addition, the material of tool bin unit 700 may vary depending on design and strength characteristics.

FIG's. 8A, 8B, and 8C illustrate a perspective front view of a tool strap unit 102 and one assembly method of the tool strap unit 102 in accordance with an embodiment of the present disclosure. In FIG.8C, the drawing depicts strap passage 806 which allows strap 204 to pass through the backing plate 202. Slip stoppers 810, in this application, offer a non-slip surface between the magnet 302 and the metal sheet 106. The non-slip surface of slip-stoppers 810 may increase the holding power of the magnet 302. The drawing also shows a male bolt 802 and female bolt 804. Male bolt 802 and female bolt 804 pass through bolt cavity 808 to bond together slip stoppers 810, magnet 302, backing plate 202, strap 204, and grippers 206. The assembly method depicted will allow the separate creation of components for final assembly afterwards.

FIG's. 9A, 9B and 9C illustrate a rear perspective view, a cross sectional side view, and a front perspective view of tool strap unit 102 in accordance with an embodiment of the present disclosure. The drawings show a male bolt 802 and female bolt 804. The male bolt 802 and female bolt 804 pass through the bolt cavity 808 to bond together the slip stoppers 810, magnet 302, backing plate 202, tool strap unit 102, and grippers 206. In this embodiment strap 204 is placed between backing plate 202 and gripper 206. Other means of retaining strap 204, other than gripper 206, may include a washer or bolt head and the like. This allows for strap 204 to rotate 902 around the central axis of male bolt 802 and female bolt 804, thus offering great flexibility in tool 110 usage. The assembly method depicted will allow the separate creation of components for final assembly afterwards.

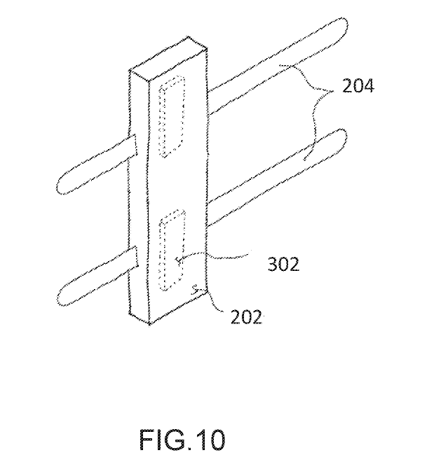

FIG. 10 illustrates magnet 302 being formed within, or covered by, backing plate 202 material. This embodiment may increase friction between tool strap unit 102 and metal plate 106.

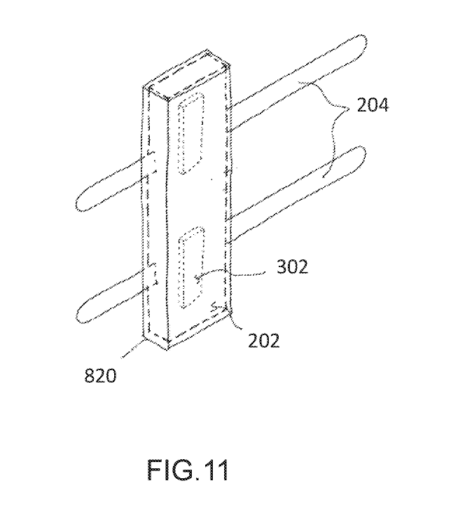

FIG. 11 illustrates encapsulation of tool strap unit 102 with a non-slip material 820 to offer the same benefits as discussed for FIG.10, but with a varying method of production. This method of production may include secondary molding of the entire tool strap unit 102 upon completion, or a dip method of a non-slip material (e.g., rubber, silicon, composite, etc.).

Additional embodiments and variations, as based on the aforementioned descriptions and accompanying figures, may be appreciated by one skilled in the art. One such embodiment may be the use of two or more tool strap units 102 with a single tool to enhance the holding capabilities to compensate for the size, weight, or shape of tool 110.

Although the disclosure has been described with reference to certain preferred embodiments, it will be appreciated by those skilled in the art that modifications and variations may be made without departing from the spirit and scope of the disclosure. It should be understood that applicant does not intend to be limited to the particular details described above and illustrated in the accompanying drawings.

I claim:

1. A tool storage system comprising:
a metal sheet mounted to a wall;
a backing plate having a front surface, a back surface, a first vertical side, a second vertical side, a top side and a bottom side;
the backing plate having a horizontal passage extending from the first vertical side of the backing plate to the second vertical side of the backing plate;
at least one strap, with each strap having a first strap end and a second strap end, wherein a portion of the at least one strap is contained within the horizontal passage, wherein the first strap end and the second strap end are separated by the portion of the at least one strap contained within the horizontal passage;
wherein a first end of the at least one strap is adapted to adhere to a second end of the at least one strap;
wherein the backing plate is attached to at least one magnet, wherein the at least one magnet is positioned on a back surface of the backing plate;
wherein the at least one magnet is adapted to magnetically adhere to the metal sheet such that when the at least one magnet is attached to the metal sheet the at least one magnet is positioned between the metal sheet and the backing plate.

2. The tool storage system of claim 1, wherein the backing plate is divided into a first backing plate section and a second backing plate section; wherein the first backing plate section and the second backing plate section are connected by a hinge; wherein a first side of the first backing plate section has at least one magnet attached, and a first side of the second backing plate section has at least one magnet attached.

3. The tool storage system of claim 2, wherein the first backing plate section and the second backing plate section are of an identical shape, each having a triangular portion and a rectangular portion, wherein a vertex of the triangular portion of the first backing plate section is linked by a central hinge to a vertex of the triangular portion of the second backing plate section, such that the first backing plate section and the second backing plate section rotate latitudinally to form a 90 degree angle between a longitudinal axis of the first backing plate section and the second backing plate section.

4. The tool storage system of claim 3, wherein the central hinge is bi-directional, thereby allowing the first backing plate section and the second backing plate section to rotate in either direction.

5. The tool storage system of claim 2, wherein the first backing plate section and the second backing plate section are rectangular, wherein the first backing plate section is linked by a hinge to the second backing plate section; wherein the hinge is positioned along a divide between a first vertical side of the first backing plate section and a first vertical side of the second backing plate section.

6. The tool storage system of claim 5, wherein the hinge is a 180-degree hinge.

7. The tool storage system of claim 5, wherein the hinge is a 90-degree hinge.

8. The tool storage system of claim 1, wherein the horizontal passage is rectangular, wherein a first vertical end of the horizonal passage and a second vertical end of the horizontal passage are equal in length to each other and greater in length than a first horizontal side of the horizontal passage and a second horizontal side of the horizontal passage, such that the horizontal passage is rectangular in shape.

9. The tool storage system of claim 1, further comprising a plurality of metal sheets, wherein the tool storage system is modular such that a user can add additional metal sheets to create a greater overall metal sheet surface area.

10. The tool storage system of claim 1, wherein a plurality of mounting holes are positioned throughout on the metal sheet.

11. The tool storage system of claim 1, wherein the at least one magnet is molded into the back surface of the backing plate such that the at least one magnet is flush with the back surface of the backing plate;

12. The tool storage system of claim 1, wherein the at least one magnet is coated with a non-slip material.

13. The tool storage system of claim 1, wherein the backing plate is comprised of at least one of plastic, silicone, carbon fiber, or wood.

14. The tool storage system of claim 1, further comprising at least two straps and at least two horizontal passageways through which the at least two straps pass.

15. The tool storage system of claim 1, further comprising a plurality of slip stoppers;
wherein the plurality of slip stoppers are positioned between the at least one magnet and the metal sheet; wherein a male bolt and a female bolt pass through a bolt cavity to hold the plurality of slip stoppers.

16. The tool storage system of claim 1, further comprising a plurality of grippers; wherein the plurality of grippers are positioned between the backing plate and a tool.

17. A tool storage system comprising:
a metal sheet mounted to a wall;
a backing plate having a front surface, a back surface, a first vertical side, a second vertical side, a top side and a bottom side;
the backing plate having a horizontal passage extending from the first vertical side of the backing plate to the second vertical side of the backing plate;
at least one strap having a first strap end and a second strap end, wherein the at least one strap is attached to the backing plate;
wherein a first end of the at least one strap is adapted to adhere to a second end of the at least one strap;
wherein the backing plate is attached to at least one magnet, wherein the at least one magnet is positioned on a back surface of the backing plate;
wherein the at least one magnet is adapted to magnetically adhere to the metal sheet such that when the at least one magnet is attached to the metal sheet the at least one magnet is positioned between the metal sheet and the backing plate.

18. The tool storage system of claim 17, wherein the at least one strap is attached to the backing plate between the backing plate and a bolt head, wherein a hole in the at least one strap allows a bolt to pass through the at least one strap, thereby allowing the at least one strap to rotate around a central axis of the bolt.

19. The tool storage system of claim 18, the at least one strap is positioned between a gripper and the backing plate.

20. A tool storage system comprising:
a metal sheet mounted to a wall;
a backing plate;
wherein the backing plate is attached to at least one magnet, wherein the at least one magnet is positioned on a first side of the backing plate;
wherein the at least one magnet is adapted to magnetically adhere to the metal sheet such that when the at least one magnet is attached to the metal sheet the at least one magnet is positioned between the metal sheet and the backing plate;
wherein at least one of a hook or a bin is attached to a second side of the backing plate for holding a tool.
